(19) United States
(12) Patent Application Publication
(10) Pub. No.: US 2025/0266749 A1
(43) Pub. Date: Aug. 21, 2025

(54) NON-LINEAR ANALOGUE CONTROL OF A MULTI-PHASE ELECTRICAL CIRCUIT

(71) Applicant: 3D PLUS, BUC (FR)

(72) Inventor: Thomas HARMAND, PALAISEAU (FR)

(21) Appl. No.: 19/054,887

(22) Filed: Feb. 16, 2025

(30) Foreign Application Priority Data
Feb. 21, 2024 (FR) 2401676

(51) Int. Cl. H02M 1/00; H02M 3/156

(52) U.S. Cl. CPC H02M 1/0043; H02M 3/156

(57) ABSTRACT

A multi-phase electrical circuit, for powering a target load, includes: a power cell having N power supply branches, which converge towards the output node; a control circuit including: a voltage regulation circuit to generate an alternating binary regulation signal based on a combination of the output voltage with a noise voltage; a distribution circuit to generate, for each power supply branch, at least one dedicated activation signal based on the regulation signal; with the plurality of activation signals being phase-shifted relative to each other according to a phase shift that varies over time.

### CROSS-REFERENCE TO RELATED APPLICATION

This application claims priority to foreign French patent application No. FR 2401676, filed on Feb. 21, 2024, the disclosure of which is incorporated by reference in its entirety.

### FIELD OF THE INVENTION

The present invention relates to multi-phase electrical circuits for space applications. More specifically, the invention relates to the implementation of non-linear and analogue control of multi-phase circuits.

### BACKGROUND

Multi-phase converters are integrated into electrical power supply systems in order to improve energy efficiency, to optimize voltage regulation and to manage the load in a more balanced manner. They operate with electrical signals that are distributed over several phases, allowing balanced load distribution. These converters are versatile, being able to convert between DC and AC voltages, and to regulate the voltage or the current in order to address the specific needs of electrical devices.

Within the context of a multi-phase converter, “phase” is understood to mean an individual power supply branch of the electrical circuit that converts electrical energy. Multi-phase converters use several such phases, typically two, three or more, which operate independently in order to convert energy. Each phase operates with a time shift relative to the others, thus creating a time sequence in which each phase successively contributes to the total output of the converter. This approach distributes the electrical load and reduces current variations, which can result in improved efficiency and reduced current ripples. For example, in a two-phase converter, two phases operate alternately in order to reduce the voltage. Similarly, a three-phase converter would involve three phases operating in succession.

A multi-phase converter generally comprises a power cell formed by the plurality of phases and a control circuit configured to control the activation and the deactivation of the various phases in order to achieve the operational time shift of the phases relative to each other.

As the power requirements of computing units increase, voltage regulator modules (VRMs) need to supply more current, while improving their responsiveness to load transistors. To this end, the use of multi-phase or multi-phase series-capacitor topologies is favoured. Combining these topologies with non-linear control optimizes the performance capabilities of these converters. However, applying effective non-linear control to multi-phase or multi-phase series-capacitor converters is complex, particularly in applications that do not include a digital controller, such as a microprocessor, an FPGA or a processor.

More specifically, implementing the control circuit using digital controllers results in a circuit with degraded technological robustness within the context of space applications. Indeed, conventional digital control circuits often exhibit limitations in terms of reliability in the extreme environments of space. Currently available solutions are often based on conventional digital control circuits that are not optimized for the specific constraints of space, notably radiation resistance, reliability and stability.

### SUMMARY OF THE INVENTION

The invention attempts to solve the problem relating to changes in the operating frequencies of the control signals of the various phase-shifted phases. Indeed, when the control circuit is not governed by a fixed clock frequency, it becomes difficult to generate phase-shifted control signals with an indeterminate frequency. In this case, the control circuit must phase-shift the control signals based on a single input signal, without first knowing when the next phase will be triggered. This is referred to as the design of a “non-linear” control circuit.

For the purposes of describing the invention, the term “power supply branch” will be used to designate the electrical phases of a multi-phase circuit.

One or more responses to the problem(s) and solution(s) are provided as follows.

In order to overcome the limitations of the existing solutions, the invention proposes a multi-phase electrical circuit with a non-linear and analogue phase control circuit. The non-linearity of the control circuit allows a main command to be phase-shifted over several phases without knowing its duration. In addition, the architecture proposed according to the invention allows the stability of the operation of the multi-phase circuit to be improved independently of the output load, which can be adjusted according to the intended application.

The analogue implementation of the control circuit according to the invention ensures that the multi-phase circuit is compatible with a hostile environment and more specifically with a space environment. This offers superior reliability to digital microcontrollers that are sensitive to the environmental constraints for a space application.

The subject of the invention is a multi-phase electrical circuit configured to generate an output current or an output voltage for powering a target load. Said multi-phase electrical circuit comprises:
a power cell comprising:
   an input node for supplying an input voltage;
   an electrical ground;
   an output node for supplying said output voltage;
   N power supply branches, which converge towards the output node, with N being a natural number greater than 1, each power supply branch comprising:
      a central node separated from the input node by at least one first switch and from the electrical ground by at least one second switch;
a control circuit comprising:
   a voltage regulation circuit configured to generate an alternating binary regulation signal based on the combination of the output voltage with an alternating noise voltage, with said noise voltage being generated by the voltage regulation circuit based on:
      the electrical potential of the central node of a selected power supply branch; or
      based on the input voltage;
   a distribution circuit configured to generate, for each power supply branch, at least one dedicated activation signal based on the regulation signal, with the plurality of activation signals being phase-shifted relative to each other according to a phase shift that varies over time.

According to a particular aspect of the invention, the voltage regulation circuit comprises a comparator for comparing an intermediate signal with a predetermined reference voltage. Said intermediate signal has a DC component corresponding to the output voltage and an AC component corresponding to the noise voltage.

According to a particular aspect of the invention, the voltage regulation circuit comprises a divider bridge comprising a pair of resistors separated by a third switch and configured to generate a fraction of the input voltage when the third switch is on, with the third switch being controlled by the regulation signal.

According to a particular aspect of the invention, the voltage regulation circuit comprises N diodes, such that each diode has an anode connected to the central node of a power supply branch associated with said diode and such that the cathodes of the diodes are connected to a common node separated from the electrical ground by a fourth switch controlled by the regulation signal.

According to a particular aspect of the invention, the distribution circuit comprises a chain of N D-type flip-flops all synchronized according to the regulation signal and mounted such that: the output of a flip-flop of rank i=1 to N−1 is connected to the input of the next flip-flop of rank i+1.

According to a particular aspect of the invention, the distribution circuit further comprises an OR-type logic cell having a first input connected to the output of the flip- flop of rank N, a second input receiving an initialization signal and an output connected to the input of the flip-flop of rank i=1.

According to a particular aspect of the invention, the distribution circuit further comprises N AND-type logic cells, with each AND-type cell having a first input receiving the output of an associated D-type flip-flop and a second input receiving the regulation signal and an output for supplying the activation signal to an associated power supply branch.

According to a particular aspect of the invention, the control circuit further comprises a protection circuit inserted between the voltage regulation circuit and the distribution circuit and configured to limit, to a predetermined threshold, the duration for setting the regulation signal to a high or low state.

According to a particular aspect of the invention, the control circuit further comprises a dead time circuit inserted between the distribution circuit and the power cell and configured to generate, for each power supply branch, a first and a second supplementary activation signal, with each transition edge of the second activation signal being temporally shifted relative to the first activation signal.

According to a particular aspect of the invention, each power supply branch comprises an associated elementary inductor mounted between the central node and the output node, with each power supply branch being configured to generate an elementary current through the associated elementary inductor.

### BRIEF DESCRIPTION OF THE DRAWINGS

Further features and advantages of the present invention will become more clearly apparent upon reading the following description with reference to the following appended drawings.

FIG. 1 illustrates a multi-phase electrical circuit according to a first embodiment of the invention.

FIG. 2a illustrates a first example of a power cell of the multi-phase electrical circuit according to the invention.

FIG. 2b illustrates a second example of a power cell of the multi-phase electrical circuit according to the invention.

FIG. 3a illustrates a first example of a voltage regulation circuit of the multi-phase electrical circuit according to the invention.

FIG. 3b illustrates a second example of a voltage regulation circuit of the multi-phase electrical circuit according to the invention.

FIG. 4 illustrates the control signal distribution circuit of the multi-phase electrical circuit according to the invention.

FIG. 5 illustrates a timing chart of the internal and external signals of the control circuit of the multi-phase electrical circuit according to the invention.

FIG. 6 illustrates a multi-phase electrical circuit according to a second embodiment of the invention.

FIG. 7a illustrates an example of the implementation of the protection circuit in the multi-phase electrical circuit according to a second embodiment of the invention.

FIG. 7b illustrates a RESET signal generation circuit in the multi-phase electrical circuit according to a second embodiment of the invention.

FIG. 7c illustrates a SET signal generation circuit in the multi-phase electrical circuit according to a second embodiment of the invention.

### DETAILED DESCRIPTION

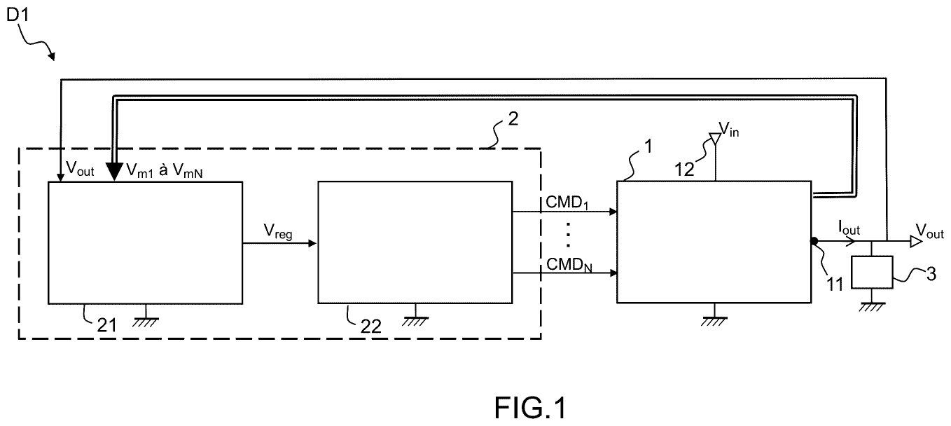

FIG. 1 illustrates a multi-phase electrical circuit D1 according to a first embodiment of the invention. The multi-phase electrical circuit D1 comprises a power cell 1 and a control circuit 2. The power circuit 1 is formed by N power supply branches with indices i=1 to N configured to generate an output current lout towards a load 3 to be powered. The control circuit 2 is configured to generate activation signals CMDᵢ, with i=1 to N, phase-shifted relative to each other according to a phase shift that varies over time. Each activation signal CMDᵢ is dedicated to the power supply branch with the same index i in order to trigger said power supply branch to power the load 3 over a duration. The activated power supply branch is then in a conduction state.

The power cell 1 comprises an input node 12 for supplying an input voltage Vᵢₙ, an electrical ground GND, an output node 11 for supplying said output voltage Vₒᵤₜ and the N power supply branches, which converge towards the output node 11. The load 3 to be powered is connected between the output node 11 and the ground GND. The power cell 1 generates:
the output current Iₒᵤₜ through the load 3 to be powered;
the output voltage Vₒᵤₜ at the terminals of the load 3 and propagated via a first feedback loop towards the control circuit 2;
at least one noise voltage Vₘ₁ to V_{mN} reinjected via a second feedback loop towards the control circuit 2.

The control circuit 2 comprises a voltage regulation circuit 21 and a distribution circuit 22. The voltage regulation circuit 21 is configured to generate a regulation signal V_{reg} based on the combination of the DC component of the back-propagated output voltage Vₒᵤₜ with the AC component of the noise voltage selected from among at least one noise voltage Vₘ₁ to V_{mN} reinjected via the second feedback loop. The regulation signal V_{reg} is a binary and periodic digital signal intended for the distribution circuit 22.

The distribution circuit 22 is configured to generate, for each power supply branch, a dedicated activation signal CMD₁, CMD₂, CMD₃ based on the regulation signal V_{reg}. The activation signals are phase-shifted relative to each other by a phase shift that varies over time. The regulation signal V_{reg} has a source signal, from which the multiple activation signals CMDᵢ will be generated with a variable phase shift, allowing the power supply branches of the power cell 1 to be sequentially activated without requiring a synchronization clock signal.

Reinjecting the output voltage Vₒᵤₜ and the noise voltage Vₘᵢ into the control circuit 2 allows a stable multi-phase electrical circuit D1 to be acquired independently of the required activation frequency of the power supply branches.

The noise voltage Vₘᵢ is in phase with the conduction of each of the power supply branches in order to achieve operation that is independent of the load and that can be adjusted according to the intended application. In addition, this noise generation allows a regulation signal V_{reg} to be generated, which signal reproduces the variation over time of the current flowing through the associated power supply branch.

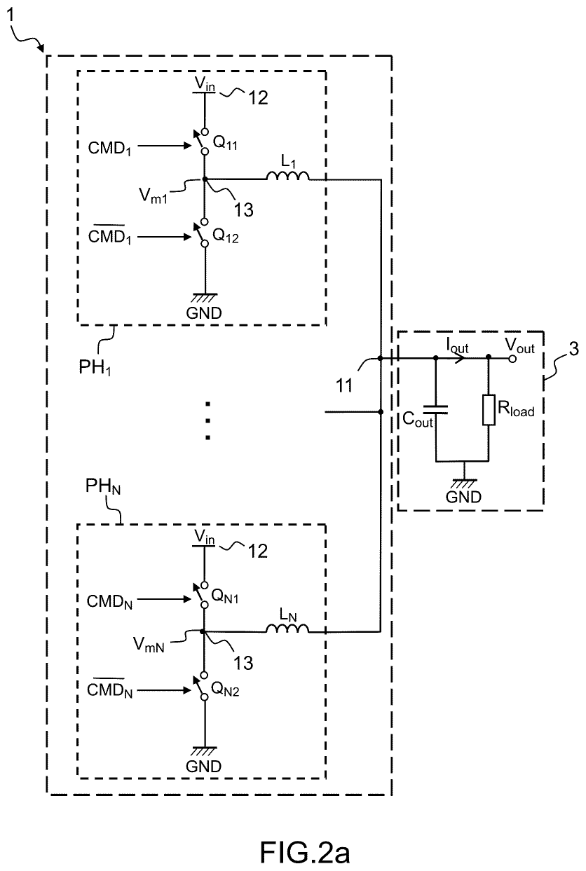

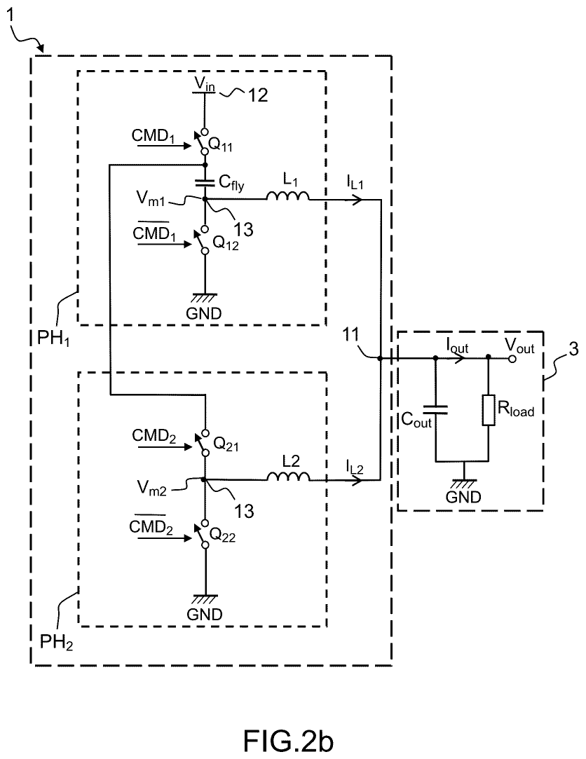

FIG. 2a illustrates a first example of a power cell 2 of the multi-phase electrical circuit D1 according to the invention. In this illustrative and non-limiting example, the power cell 2 is a multi-phase Buck converter for converting the DC input voltage Vᵢₙ to an output voltage Vₒᵤₜ that is lower than the input voltage. The output voltage Vₒᵤₜ is measured on the output node 11. The power cell 2 comprises a plurality of power supply branches PH₁ to PH_{N}, which converge towards the output node 11. The target load 3 is made up of, for example, a load capacitor Cₒᵤₜ and a load resistor R_{load} mounted in parallel between the output node 11 and the electrical ground GND.

Each power supply branch PHᵢ comprises a first switch Qᵢ₁, a second switch Qᵢ₂, a central node 13, and an associated elementary inductor Lᵢ mounted between the central node 13 and the output node 11. For each power supply branch PHᵢ, the central node 13 is separated from the input node 12 by at least the first associated switch Qᵢ₁. For each power supply branch PHᵢ, the central node 13 is separated from the ground GND by at least the second associated switch Qᵢ₂. The first switch Qᵢ₁ is controlled by the activation signal CMDᵢ associated with the power supply branch PHᵢ. The second switch Qᵢ₂ is controlled by the supplementary activation signal CMDᵢ associated with the power supply branch PHᵢ. For example, when the activation signal CMDᵢ is in a high state, the first switch Qᵢ₁ is in an on-state and the second switch Qᵢ₂ is in an off-state. This induces a flow of current through the power supply branch PHᵢ from the input node 12 to the output node 11, through the associated central node 13 and the associated elementary inductor Lᵢ. Conversely, when the activation signal CMDᵢ is in a low state, the first switch Qᵢ₁ is in an off-state and the second switch Qᵢ₂ is in an on-state. This causes the central node 13 to be connected to the ground GND and the current in the power supply branch PHᵢ to be absent. The various activation signals CMDᵢ are phase-shifted so that each power supply branch operates with a time shift relative to the others, which helps to distribute the load and reduce current fluctuations. This reduces current ripples and energy losses. By distributing the load over several power supply branches PHᵢ, the converter can better manage current variations.

FIG. 2b illustrates a second example of a power cell 2 of the multi-phase electrical circuit D1 according to the invention. In this illustrative and non-limiting example, the power cell 2 is a series-capacitor multi-phase Buck converter for converting the DC input voltage Vin to an output voltage Vₒᵤₜ that is lower than the input voltage. The power cell 2 according to the second example incorporates all the features and advantages set forth for the first example. The power cell 2 according to the second example differs from the first example as follows: each power supply branch PHᵢ, with i=1 to N−1, further comprises an intermediate capacitor C_{fly} mounted in series between the first switch Qᵢ₁ and the central node 13. In addition, for each power supply branch PHᵢ, with i=1 to N−1, the common node between the intermediate capacitor C_{fly} and the first switch Qᵢ₁ is connected to the first switch Q₍ᵢ₊₁₎₁ of the next power supply branch PHᵢ₊₁. The last power supply branch of rank i=N is devoid of the intermediate capacitor C_{fly}. Only the initial power supply branch PH₁ is connected to the input node 12 via its first switch Q₁₁. The power cell 2 according to the second example has better technical robustness than the first example, because the first and second switches Qᵢ₁ and Qᵢ₂ have voltages at their terminals that are lower than the input voltage Vᵢₙ.

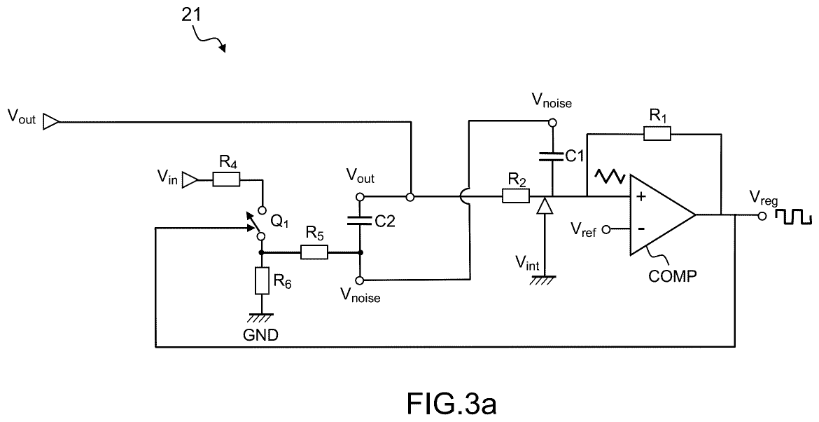

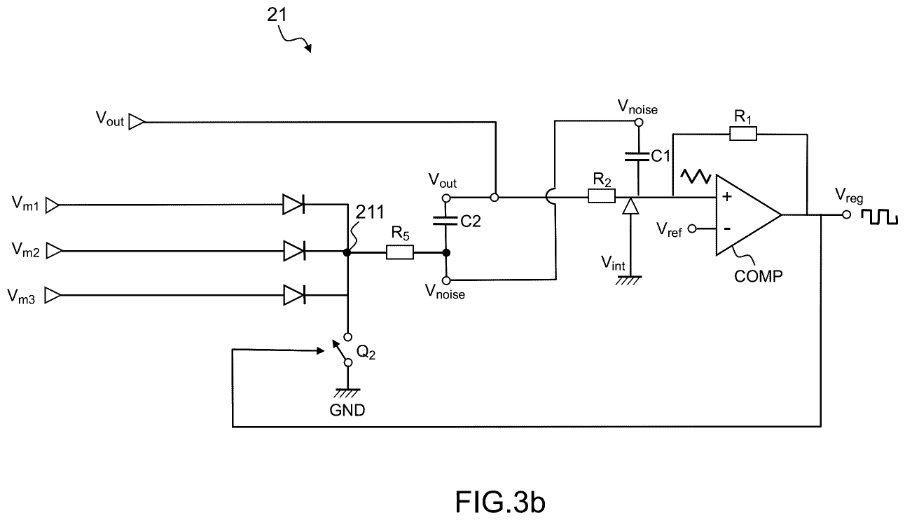

FIG. 3a illustrates a first example of the voltage regulation circuit 21 of the control circuit 2 according to the invention. The voltage regulation circuit 21 is configured to generate an alternating binary regulation signal V_{reg} based on the combination of the output voltage Vₒᵤₜ with a noise voltage Vₙₒᵢₛₑ.

In the first example, the voltage regulation circuit 21 comprises a resistive divider bridge formed by a pair of resistors R4, R6 separated by a switch Q₁. The resistive divider bridge R4, R6 is configured to generate a fraction of the input voltage Vᵢₙ when the switch Q₁ is on. The third switch Q₁ is controlled by the regulation signal V_{reg} via a feedback loop inside the voltage regulation circuit 21. The divider bridge R4, R6 controlled by the regulation signal V_{reg} generates a noise voltage Vₙₒᵢₛₑ that is synchronized with the regulation signal V_{reg}. The resistive divider bridge is designed so as to obtain a noise voltage Vₙₒᵢₛₑ, when the switch Q₁ is on, that is equal to the voltage that can be measured at the central node 13 of the activated power supply branch PHᵢ. The injection of the synchronized noise voltage Vₙₒᵢₛₑ ensures that the currents flowing through the various power supply branches are equal. Thus, the stability of the converter D1 is guaranteed without having to measure current. Moreover, the voltage regulation circuit 21 receives the output voltage Vₒᵤₜ from the output node 11 propagated via the first feedback loop of the multi-phase electrical circuit D1 described in FIG. 1. The combination of the internally generated noise voltage Vₙₒᵢₛₑ with the back-propagated output voltage Vₒᵤₜ forms an intermediate voltage Vᵢₙₜ. The voltage regulation circuit 21 further comprises a comparator COMP configured to compare an intermediate signal Vᵢₙₜ with a predetermined reference voltage V_{ref}. The output signal of the comparator COMP is the regulation signal V_{reg}, which is a periodic binary signal.

The voltage regulation circuit 21 further comprises a resistor R2 connected between the output node supplying the output voltage Vₒᵤₜ and the non-inverting input of the comparator COMP corresponding to the intermediate signal Vᵢₙₜ. The resistor R2 allows the DC component of the output voltage Vₒᵤₜ to be superimposed on the non- inverting input of the comparator COMP.

The voltage regulation circuit 21 further comprises a capacitor C2 mounted, on the one hand, between the node supplying the output voltage Vₒᵤₜ and, on the other hand, the node supplying the noise voltage Vₙₒᵢₛₑ. The capacitor C2 allows the noise voltage Vₙₒᵢₛₑ to be integrated through at least the resistor R4, so as to obtain a triangular signal between the output voltage Vₒᵤₜ and the noise voltage Vₙₒᵢₛₑ.

The voltage regulation circuit 21 further comprises a capacitor C1 mounted, on the one hand, between the output node supplying the output voltage Vₒᵤₜ and, on the other hand, the non-inverting input of the comparator COMP corresponding to the intermediate signal Vᵢₙₜ. The capacitor C1 acts as a high-pass filter. The capacitor C1 allows the AC component of the noise voltage Vₙₒᵢₛₑ to be superimposed on the non-inverting input of the comparator COMP. This produces an intermediate signal Vᵢₙₜ with a DC component corresponding to the output voltage Vₒᵤₜ and an AC component corresponding to the noise voltage Vₙₒᵢₛₑ. The impedance of the capacitor C1 is lower than the impedance of the resistor R2 at the operating frequency. This prevents a voltage drop between the noise voltage Vₙₒᵢₛₑ and the intermediate signal Vᵢₙₜ.

The voltage regulation circuit 21 internally generates a triangular intermediate signal Vᵢₙₜ that is synchronized with the current of the branch on an input of the comparator COMP with two activation thresholds. The intermediate signal Vᵢₙₜ reproduces the shape of the current flowing through the inductor of the conducting power supply branch. This produces the binary periodic regulation signal V_{reg} at a frequency f_{reg} that is determined by the time constant R4.C2 and by the values of the two hysteresis thresholds of the comparator COMP.

Optionally, the voltage regulation circuit 21 further comprises a resistor R5 mounted, on the one hand, between the node supplying the noise voltage Vₙₒᵢₛₑ and, on the other hand, the output of the voltage divider bridge R4, R6. In this case, the frequency f_{reg} is determined by the time constant (R4+R5).C2 by the values of the two hysteresis thresholds of the comparator COMP. The addition of the resistor R5 provides an additional degree of freedom for dimensioning the frequency f_{reg}.

FIG. 3b illustrates a second example of the voltage regulation circuit 21 of the control circuit 2 according to the invention. The voltage regulation circuit 21 is configured to generate an alternating binary regulation signal V_{reg} based on the combination of the output voltage Vₒᵤₜ with a noise voltage Vₙₒᵢₛₑ.

In the second example, the voltage regulation circuit 21 comprises N diodes Dᵢ of rank i=1 to N, with N being the number of power supply branches PHᵢ. In this example, N=3 is considered. Each diode Dᵢ of rank i has an anode connected to the central node 13 of the power supply branch PHᵢ associated with said diode Dᵢ. The cathodes of the diodes Dᵢ are connected to a common node 211. The common node 211 is separated from the electrical ground GND by a switch Q₂. The switch Q₂ is controlled by the regulation signal V_{reg} via a feedback loop inside the voltage regulation circuit 21. For any one of the power supply branches PHᵢ, when the first switch Qᵢ₁ is on, the central node 13 is at a non-zero central voltage Vₘᵢ. The corresponding diode Dᵢ is subjected to a positive voltage and thus becomes conducting. The other diodes Dⱼ (with j≠i) are in the off-state. The central voltage Vₘᵢ is thus propagated towards the common node 211 in order to form the noise voltage Vₙₒᵢₛₑ. This noise signal allows the image of the current flowing through the elementary inductor Lᵢ of the activated power supply branch PHᵢ to be added to the regulation loop. This ensures the distribution of the currents in the inductors Lᵢ if they are identical. Activating the switch Q₂ ensures that the common node 211 is grounded when all the power supply branches are deactivated.

Moreover, the voltage regulation circuit 21 receives the output voltage Vₒᵤₜ from the output node 11 propagated via the first feedback loop of the multi-phase electrical circuit D1 described in FIG. 1. The combination of the internally generated noise voltage Vₙₒᵢₛₑ with the back-propagated output voltage Vₒᵤₜ forms an intermediate voltage Vᵢₙₜ. The noise voltage Vₙₒᵢₛₑ is propagated towards a common node with the output voltage Vₒᵤₜ. The intermediate signal Vᵢₙₜ thus has a DC component corresponding to the output voltage Vₒᵤₜ and an AC component corresponding to the noise voltage Vₙₒᵢₛₑ.

The voltage regulation circuit 21 further comprises a comparator COMP configured to compare an intermediate signal Vᵢₙₜ with a predetermined reference voltage V_{ref}. The output signal of the comparator COMP is the regulation signal V_{reg}, which is a periodic binary signal.

In general, the voltage regulation circuit 21 generates a periodic binary regulation signal V_{reg} from an intermediate voltage Vᵢₙₜ with a DC component corresponding to the output voltage Vₒᵤₜ and an AC component corresponding to the noise voltage Vₙₒᵢₛₑ. This combination ensures that the currents flowing through the various power supply branches are equal and thus improves the stability of the converter D1.

Alternatively, according to a particular embodiment, the N diodes Dᵢ of rank i=1 to N are replaced by N switches controlled by external signals. By way of an example, the switches are made by transistors. In this case, it is possible to dispense with the switch Q₂.

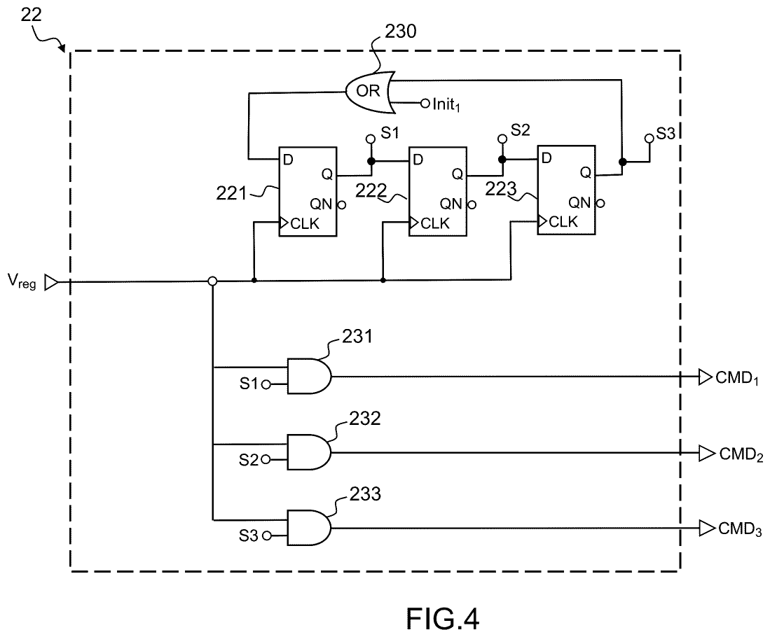

FIG. 4 illustrates the distribution circuit 22 of the control circuit 2 according to the invention. The distribution circuit 22 receives the regulation signal V_{reg} generated by the voltage regulation circuit 21. The distribution circuit 22 is configured to generate, for each power supply branch PHᵢ, a dedicated activation signal CMDᵢ from the regulation signal V_{reg}. The activation signals CMDᵢ are phase shifted relative to each other without requiring an external clock signal with a fixed frequency. The distribution circuit 22 comprises a chain of N D-type flip-flops, where N is the number of power supply branches PHᵢ. By way of a non-limiting example, an example is described with three power supply branches and therefore three D-type flip-flops, denoted 221, 222, 223. The flip-flops 221, 222, 223 are all synchronized by the regulation signal V_{reg}. The flip-flops 221, 222, 223 are mounted such that the output sᵢ of a flip-flop of rank i=1 to N−1 is connected to the input of the next flip-flop of rank i+1. The chain of N flip-flops forms a shift register.

The distribution circuit 22 comprises an OR logic cell 230 with a first input connected to the output s₃ of the last flip-flop 223, a second input receiving an initialization signal Init1, and an output connected to the input of the flip-flop of rank i=1. The logic cell 230 is used to initialize the chain of flip-flops by injecting a high logic state at the input of the initial flip-flop of rank i=1 when the initialization signal Init1 is in a high logic state. During an initialization step that precedes the operation of the converter, the initialization signal Init1 is in a high logic state “1” so as to obtain a logic value “1” on the input of the flip-flop 221 of rank i=1. The inputs and outputs of the other flip-flops in the chain are in a low logic state “0”. Initially, the output of the flip-flop 221 of rank i=1 is in the low logic state “0”. The distribution circuit 22 further comprises N AND logic cells. In the illustrated example, these are the three AND cells denoted 231, 232 and 233. Each AND cell has a first input receiving the output of an associated D flip-flop. Each AND cell has a second input receiving the regulation signal V_{reg}. Each AND cell is intended to supply the activation signal CMDᵢ to an associated power supply branch PHᵢ. The first AND cell 231 receives the output signal sᵢ originating from the flip-flop 221 and generates the activation signal CMD₁ for controlling the power supply branch PHᵢ of rank i=1. The second AND cell 232 receives the output signal s₂ originating from the flip-flop 222 and generates the activation signal CMD₂ for controlling the power supply branch PH₂ of rank i=2. The third AND cell 233 receives the output signal s₃ originating from the flip-flop 223 and generates the activation signal CMD₃ for controlling the power supply branch PH₃ of rank i=3.

In general, a power supply branch PHᵢ supplies current to the load circuit when the associated activation signal CMDᵢ is in a high logic state “1”. The associated activation signal CMDᵢ is in a high logic state “1” when the output signal sᵢ of the associated flip-flop and the regulation signal V_{reg} are simultaneously in the high logic state “1”.

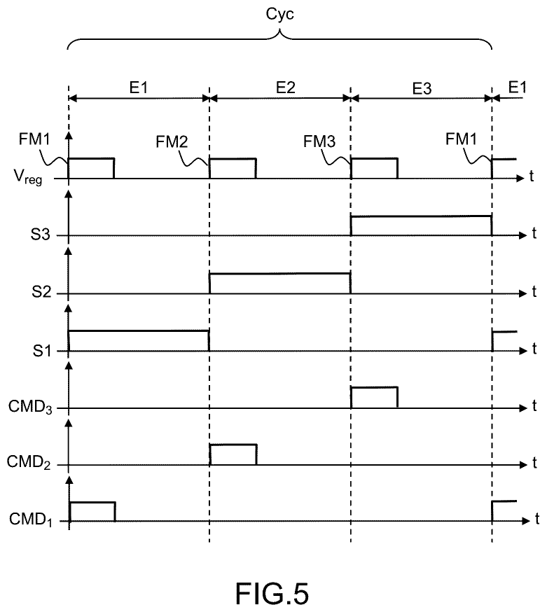

The temporal evolution of the output signals s₁, s₂ and s₃ will be described hereafter during a control cycle Cyc comprising three successive stages E1, E2 and E3, as illustrated by the timing charts in FIG. 5. FIG. 5 describes a timing chart of the internal and external signals of the control circuit 3 so as to illustrate the operation of the distribution circuit 22.

The first step E1 is triggered by the initial rising edge FM1 on the regulation signal V_{reg}. Said rising edge causes the transmission of the high logic state “1” from the input of the first flip-flop 221 to its output s₁. Thus, a high logic state “1” is only obtained on the first output s₁. The high logic state “1” on the first output s₁ is also transmitted to the input of the second flip-flop 222. The high logic state “1” is maintained on the output s₁ as long as there has been no rising edge following the initial rising edge FM1. The output signals s₂ and s₃ of the other D flip-flops in the chain are maintained in a low logic state “0”. Thus, at the start of step E1, the following configuration is obtained: the output signal s₁ of the flip-flop 221 and the regulation signal V_{reg} are simultaneously in the high logic state “1”, which generates a pulse in the high state on the activation signal CMD₁, while maintaining the other activation signals CMD₂ and CMD₃ in a low logic state. Only the power supply branch PH₁ of rank i=1 is conductive and injects a supply current towards the target load 3.

The second step E2 is triggered by the rising edge FM2 on the regulation signal V_{reg}. Said rising edge FM2 causes the high logic state “1” to be transmitted from the input of the second flip-flop 222 to its output s₂. Thus, a high logic state “1” is only obtained on the second output s₂. The high logic state “1” on the second output s₂ is also transmitted to the input of the third flip-flop 223. The OR logic cell 230 receives two low logic states “0” on its two inputs. The output s₁ of the flip-flop 221 transitions to the low logic state “0”. The high logic state “1” is maintained on the output s₂ as long as there has been no rising edge following the rising edge FM2. The output signals s₁ and s₃ of the other D flip-flops in the chain are maintained in a low logic state “0”. Thus, at the start of step E2, the following configuration is obtained: the output signal s₂ of the flip-flop 222 and the regulation signal V_{reg} are simultaneously in the high logic state “1”, which generates a pulse in the high state on the activation signal CMD₂, while maintaining the other activation signals CMD₁ and CMD₃ in a low logic state. Only the power supply branch PH₂ of rank i=2 is conductive and injects a power supply current towards the target load 3.

The third step E3 is triggered by the rising edge FM3 on the regulation signal V_{reg}. Said rising edge FM3 causes the high logic state “1” to be transmitted from the input of the third flip-flop 223 to its output s₂₃. Thus, a high logic state “1” is only obtained on the third output s₃. The high logic state “1” on the third output s₃ is also transmitted to the input of the first flip-flop 221 via the OR logic cell 230. The high logic state “1” is maintained on the output s₃ as long as there has been no rising edge following the rising edge FM3. Similarly, the rising edge FM3 causes the low logic state “0” to be propagated from the input of the second flip-flop 222 to its output s₂. The same applies to the output s₁ of the flip-flop 221. The output signals s₁ and s₂ of the other D flip-flops in the chain are thus maintained in a low logic state “0”. Thus, at the start of step E3, the following configuration is obtained: the output signal s₃ of the flip-flop 223 and the regulation signal V_{reg} are simultaneously in the high logic state “1”, which generates a pulse in the high state on the activation signal CMD₃, while maintaining the other activation signals CMD₁ and CMD₂ in a low logic state. Only the power supply branch PH₃ of rank i=3 is conductive and injects a power supply current towards the target load 3.

The distribution circuit 22 then allows phase-shifted activation signals CMDᵢ to be generated without prior knowledge of a predetermined value of the targeted phase shift or of the frequency of the regulation signal V_{reg}. The number of AND flip-flops and logic cells is equal to the number of power supply branches PHᵢ. The frequency of the regulation signal V_{reg}, which synchronizes the chain of flip-flops, is divided by the number of power supply branches N. The switching frequency f_{CMD} of each of the power supply branches PHᵢ of the converter D1 is governed by the following relationship: f_{CMD}=f_{reg}/N, where f_{reg} is the frequency of the regulation signal V_{reg} and N is the number of power supply branches PHᵢ.

The control circuit 2 further comprises means for generating signals supplementing the activation signals CMDᵢ for controlling the second switches Q_{i2.}Said means cover inverter circuits, for example.

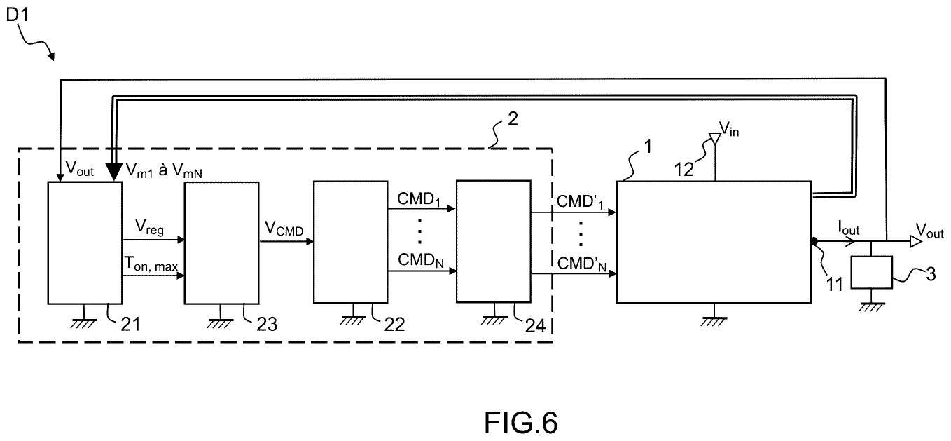

FIG. 6 illustrates a multi-phase electrical circuit D1 according to a second embodiment of the invention. In the second embodiment, the control circuit 2 further comprises a protection circuit 23 inserted between the voltage regulation circuit 21 and the distribution circuit 22. The protection circuit 23 receives the regulation signal V_{reg} from the voltage regulation circuit 21 and generates a master signal V_{CMD} towards the distribution circuit 22. The master signal V_{CMD} acts as a clock signal for the daisy-chained D flip-flops instead of the regulation signal V_{reg} compared with the first embodiment. The protection circuit 23 is configured to limit, to a predetermined threshold T_{ON,max}, the duration for setting the regulation signal V_{reg} to a high or low state. The protection circuit 23 allows the conduction time of a power supply branch PHᵢ to be limited. Controlling the maximum conduction time T_{ON,max} allows a controlled and temporary imbalance to be caused in the current flowing through the power supply branches of the converter during a transient edge of the current. This imbalance generally should be avoided, but it has been shown to improve the response time of the converter if it is allowed for a controlled duration.

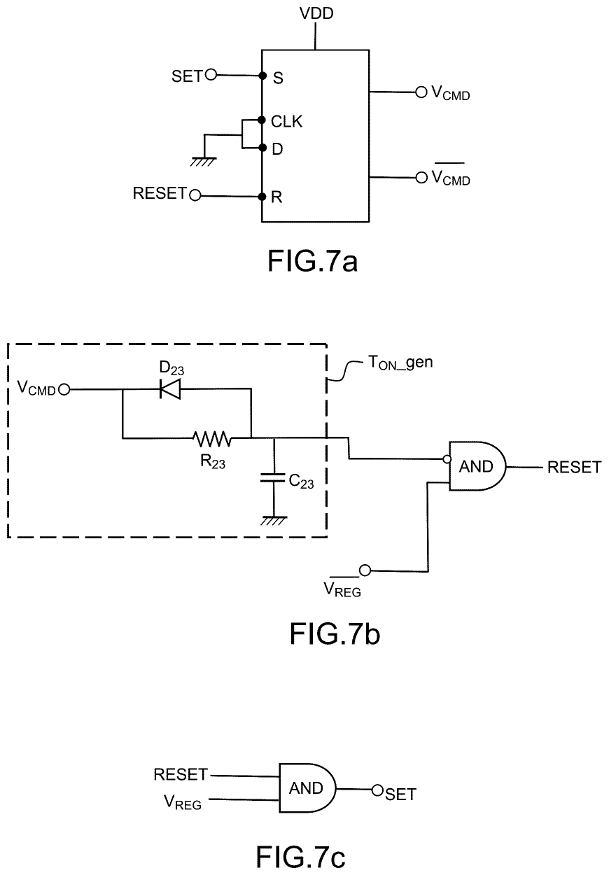

By way of an example, in order to implement the protection circuit 23, a D flip-flop can be used that is employed in SET/RESET mode, as illustrated in FIG. 7a. The SET signal sets the master signal V_{CMD} to a high state and the RESET signal returns it to a low state. In the event of a conflict, the RESET signal prevails. FIG. 7b illustrates the RESET signal generation circuit in the protection circuit 23. The master signal V_{CMD} is injected at the input of a circuit T_{on_gen} allowing the maximum activation time to be set to T_{ON,max}. The circuit T_{on_gen} comprises an RC filter formed by a resistor R₂₃ and a capacitor C₂₃, at the terminals of which the voltage of the master signal V_{CMD} is applied. The circuit T_{on_gen} further comprises a diode D₂₃, the anode of which is connected to the common node between the resistor R₂₃ and the capacitor C₂₃. The cathode of the diode D₂₃ is connected to the other pole of the resistor R₂₃. The output signal of the circuit T_{on_gen} is picked up on the common node between the resistor R₂₃ and the capacitor C₂₃ and it is propagated to a first input of an AND logic cell. The second input of the AND logic cell receives the supplementary regulation signal V_{reg} (supplied by the negative output of the comparator COMP, for example). The RESET signal is generated by the memory cell towards the D flip-flop of the protection circuit 23.

FIG. 7c illustrates the SET signal generation circuit in the protection circuit 23. This involves an AND cell receiving the already generated RESET signal on one input and the regulation signal V_{reg} on the other input.

Preferably, according to the second embodiment described in FIG. 6, the control circuit 2 further comprises a dead time circuit 24 inserted between the distribution circuit 22 and the power cell 1. The dead time circuit 24 is configured to generate, for each power supply branch, a first CMDᵢ activation signal and a second CMD_{barre,i} supplementary activation signal. Each transition edge of the second activation signal CMD_{barre,i} is temporally shifted relative to the first activation signal. This avoids cross-conduction issues between the first switch Qᵢ₁ and the second switch Qᵢ₂ in a power supply branch PHᵢ.

The implementation of the dead time circuit 24 is independent of the implementation of the protection circuit 23 in the control circuit 2 according to the invention. According to a third embodiment, the control circuit 2 comprises the voltage regulation circuit 21, a protection circuit 23 and the distribution circuit 22 as described above. According to a fourth embodiment, the control circuit 2 comprises the voltage regulation circuit 21, the distribution circuit 22 and the dead time circuit 24 as described above.

The invention is compatible with several types of multi-phase circuit, notably power converters such as DC/DC, AC/AC, AC/DC, DC/AC, as well as switched-mode power supplies (SMPS). This solution would be beneficial for any multi-phase, multi-level or hybrid converter using non-linear control. In addition, the inverters for converting direct current to alternating current (DC-AC) in solar, wind and energy storage systems could also benefit from the generation of controls according to the invention.

1. A multi-phase electrical circuit configured to generate an output current (Iₒᵤₜ) or an output voltage (Vₒᵤₜ) for powering a target load, said multi-phase electrical circuit comprising:
a power cell comprising:
an input node for supplying an input voltage (Vᵢₙ);
an electrical ground;
an output node for supplying said output voltage (Vₒᵤₜ);
N power supply branches (PH₁, PH_{N}), which converge towards the output node, with N being a natural number greater than 1, each power supply branch (PH₁, PH_{N}) comprising:
a central node separated from the input node by at least one first switch (Q₁₁, Q_{N1}) and from the electrical ground by at least one second switch (Q₁₂, Q_{N2});
a control circuit comprising:
a voltage regulation circuit configured to generate an alternating binary regulation signal (V_{reg}) based on the combination of the output voltage (Vₒᵤₜ) with an alternating noise voltage (Vₙₒᵢₛₑ), with said noise voltage (Vₙₒᵢₛₑ) being generated by the voltage regulation circuit based on:
the electrical potential of the central node of a selected power supply branch (PH₁, PH_{N}); or
based on the input voltage (Vᵢₙ);
a distribution circuit configured to generate, for each power supply branch, at least one dedicated activation signal (CMD₁, CMD₂, CMD₃) based on the regulation signal (V_{reg}), with the plurality of activation signals being phase-shifted relative to each other according to a phase shift that varies over time.

2. The multi-phase electrical circuit according to claim 1, wherein the voltage regulation circuit comprises a comparator for comparing an intermediate signal (Vᵢₙₜ) with a predetermined reference voltage, with said intermediate signal (Vᵢₙₜ) having a DC component corresponding to the output voltage (Vₒᵤₜ) and an AC component corresponding to the noise voltage (Vₙₒᵢₛₑ).

3. The multi-phase electrical circuit according to claim 1, wherein the voltage regulation circuit comprises a divider bridge comprising a pair of resistors (R4, R6) separated by a third switch (Q₁) and configured to generate a fraction of the input voltage (Vᵢₙ) when the third switch is on, with the third switch (Q₁) being controlled by the regulation signal (V_{reg}).

4. The multi-phase electrical circuit according to claim 1, wherein the voltage regulation circuit comprises N diodes (D₁, D₂, D₃), such that each diode (D₁, D₂, D₃) has an anode connected to the central node of a power supply branch associated with said diode and such that the cathodes of the diodes are connected to a common node separated from the electrical ground (GND) by a fourth switch (Q₂) controlled by the regulation signal (V_{reg}).

5. The multi-phase electrical circuit according to claim 1, wherein the distribution circuit comprises a chain of N D-type flip-flops all synchronized according to the regulation signal (V_{reg}) and mounted such that: the output of a flip-flop of rank I=1 to N−1 is connected to the input of the next flip-flop of rank I+1.

6. The multi-phase electrical circuit according to claim 5, wherein the distribution circuit further comprises an OR-type logic cell having a first input connected to the output of the flip-flop of rank N, a second input receiving an initialization signal (Init1) and an output connected to the input of the flip-flop of rank I=1.

7. The multi-phase electrical circuit according to claim 5, wherein the distribution circuit further comprises N AND-type logic cells, with each AND-type cell having a first input receiving the output of an associated D-type flip-flop and a second input receiving the regulation signal (V_{reg}) and an output for supplying the activation signal (CMD₁, CMD₂, CMD₃) to an associated power supply branch.

8. The multi-phase electrical circuit according to claim 1, wherein the control circuit further comprises a protection circuit inserted between the voltage regulation circuit and the distribution circuit and configured to limit, to a predetermined threshold, the duration for setting the regulation signal (V_{reg}) to a high or low state.

9. The multi-phase electrical circuit according to claim 1, wherein the control circuit further comprises a dead time circuit inserted between the distribution circuit and the power cell and configured to generate, for each power supply branch, a first (CMD₁, CMD₂, CMD₃) and a second (CMDN₁, CMDN₂, CMDN₃) supplementary activation signal, with each transition edge of the second activation signal being temporally shifted relative to the first activation signal.

10. The multi-phase electrical circuit according to claim 1, wherein each power supply branch (PH₁, PH_{N}) comprises an associated elementary inductor (L₁, L_{N}) mounted between the central node and the output node, with each power supply branch (PH₁, PH_{N}) being configured to generate an elementary current (I₁, I_{N}) through the associated elementary inductor.
